(19) United States
(12) Patent Application Publication
(10) Pub. No.: US 2001/0048048 A1
(43) Pub. Date: Dec. 6, 2001

(54) BACKSIDE FITTING ATTACHMENT FOR NACELLE ACOUSTIC PANELS

(76) Inventors: BRIAN L RIEDEL, AUGUSTA, KS (US); JOHN T STRUNK, DERBY, KS (US); RANDALL R CLARK, WICHITA, KS (US)

Correspondence Address: CONARD O. GARDNER, THE BOEING COMPANY, P O BOX 3707, M/S 13-08, SEATTLE, WA, 981242207

(21) Appl. No.: 09/229,547

(22) Filed: Jan. 13, 1999

(51) Int. Cl. B64C 1/06

(52) U.S. Cl. 244/53 B

(57) ABSTRACT

A method of attaching acoustic panels to aircraft structures without loss of acoustic area due to the attachment means. The invention comprises the uses of high-shear blind fasteners in combination with acoustic panels having backside laminate and ply build-up area increased in thickness to retain the blind fastener, react the bearing loads and provide adequate stiffness for bending. The present structure and method reduces acoustic panel installation cycle time by an estimated 50% while providing noise reduction.

### BACKGROUND OF THE INVENTION

1. Field of the Document

The present invention relates to noise reduction and more particularly to sound reduction structure for aircraft.

2. Description of the Prior Art Patent Literature

U.S. Pat. No. 4,235,303 to Dhoore et al.

Dhoore et al, “Combination Bulk Absorber-Honeycomb Acoustic Panels”: relates to a combination acoustic panel that provides a high percentage of acoustically effective area.

Dhoore et al. shows a sandwich structure comprising a broadband noise-suppressing bulk absorber material mounted between a back sheet and a first side of a perforated septum; and a noise suppressing honeycomb material mounted between the septum's second side and a perforated face sheet. “Thru-bolted” fasteners are used to retain the composite acoustic panel structure. In contrast, the present invention obviates the need for “thru-bolt” acoustic panel retention means.

U.S. Pat. Nos. 4,293,053 and 4,384,634 to Shuttleworth at al.

Shuttleworth et al.; “Sound Absorbing Structure”: Shuttleworth uses a combination of elastomeric and coulombic retention means for acoustic panels used in engine nacelles. The coulombic retention means utilizes rubbing contact to frictionaly damp out acoustic panel vibrations. The elastomeric retention means elastically suspend the acoustic panels and utilizes viscous damping to damp panel vibrations. Shuttleworth also uses the elastomeric material to create “standoffs” between the acoustic panel and the engine structure, effectively creating another acoustic attenuating cavity (in addition to the cavities disposed inside the acoustic panel) that communicates with the perforated acoustic panels' backside. In contrast, the present invention is not concerned with elastomeric or coulombic retention means.

U.S. Pat. No. 4,449,607

Forestier et al; “Soundproofing for a Gas Pipe, In Particular for the Fan Jet of a Turbojet, and Equipment for its Fabrication”: Forestier et al relates to an acoustic lining means for aircraft engine inlets which comprises the insitu build up of an acoustic panel sandwich of perforated facesheets and communicating core structure that defines resonant acoustical cavities. A “thru-bolted” fastener is used to retain the composite acoustic panel structure. In contrast, the present invention seeks to obviate the need for “thru-bolt” acoustic panel retention means.

U.S. Pat. No. 4,759,513

Birbragher et al.; “Noise Reduction Nacelle”: Bribragher shows an acoustic sandwich panel designed to be field “retrofittable” to engine nacelles and thrust reverser structure using conventional fasteners (col 2, row 3; col 3, rows 38 & 55). Birbragher et al. discloses a panel composition comprising an inner perforated and outer facesheets with honeycomb core therebetween. The inner and outer facesheets are bonded using adhesive film, and a plurality of preparations are disclosed for the inner facesheet composition. In contrast, there is no showing of retention means other than “conventional fasteners”.

U.S. Pat. No. 4,825,106

Anderson; “Advanced Composite Aircraft Cowl”. Anderson shows a one-piece composite engine cowl with integral “cured-in” acoustic attenuating liners. Since the acoustic panels are “cured-in” the structure during the manufacturing process, there is no need for retention means.

### Present Aircraft Industry

The aviation industry as a whole is developing and adopting technologies and procedures that reduce airplane related noise in anticipation of increasingly more stringent requirements. In the area of engines only acoustical treatment of 70-85% of the available inlet and thrust reverser surface area is accomplished due to structural attachment considerations. Current techniques comprise reinforcing the acoustic panels in the attachment zones with square edged, high-density core and thicker laminates. The reinforced areas are then “thru-bolted” using conventional fasteners. These acoustically dead structural areas reduce the overall acoustic surface area available for noise suppression. Further, present two-piece thru-bolted fastener systems are not as economical to manufacturing since the two-piece fastener requires a countersink operation on the acoustic panel.

### SUMMARY OF THE INVENTION

In view of the disadvantages hereinabove described there is described hereinafter a method of attaching acoustic panels to aircraft structures without loss of acoustic area due to the attachment means. The present invention comprises the use of high-strength blind fasteners in combination with acoustic panels having backside laminate and ply build-up areas of increased thickness to retain the blind fastener, react the bearing loads and to provide adequate stiffness for bending.

### BRIEF DESCRIPTION OF THE SEVERAL VIEWS OF THE DRAWING

A more complete appreciation of the invention and many of the attendant advantages thereof will be readily obtained as the same becomes better understood by reference to the following detailed description when considered in connection with the accompanying drawings, wherein:

FIG. 1 is an isolated perspective view of an engine inlet assembly incorporating an acoustic panel in accordance with a preferred embodiment of the invention.

FIG. 2 is a fragmentary cross section of a prior art acoustic panel assembly.

FIG. 3 is a fragmentary cross section taken along lines 3-3 of FIG. 1 of an acoustic panel assembly in accordance with a preferred embodiment of the insertion.

FIG. 4 is a fragmentary cross section taken along lines 4-4 of FIG. 1 of an acoustic panel assembly in accordance with a preferred embodiment of the insertion.

FIG. 5 is an isolated perspective view of an engine fan duct thrust reverser assembly incorporating inner and outer acoustic panels in accordance with a preferred embodiment of the invention.

FIG. 6 is a fragmentary cross section taken along lines 6-6 of FIG. 5 of a translating sleeve acoustic panel assembly in accordance with a preferred embodiment of the insertion.

FIG. 7 is an isolated perspective view of an engine fan duct thrust reverser fixed structure assembly incorporating an inner acoustic panel in accordance with a preferred embodiment of the invention.

FIG. 8 is a fragmentary cross section taken along lines 8-8 of FIG. 7 of an inner acoustic panel assembly in accordance with a preferred embodiment of the insertion.

FIG. 9 is a fragmentary cross section taken along lines 9-9 of FIG. 7 of an inner acoustic panel assembly in accordance with a preferred embodiment of the insertion.

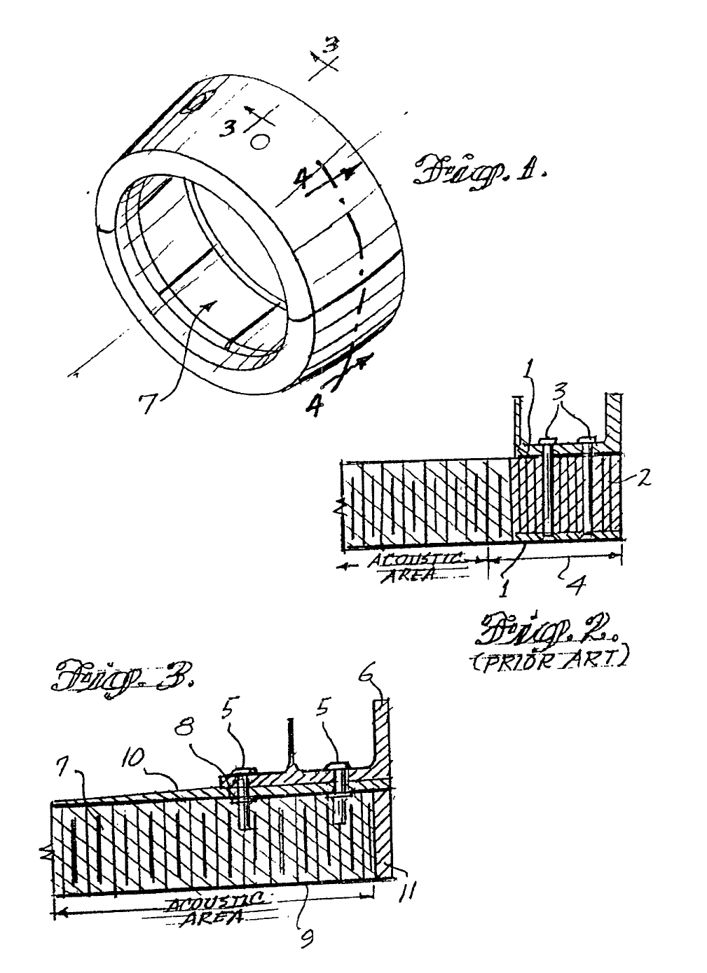

### DETAILED DESCRIPTION OF THE INVENTION

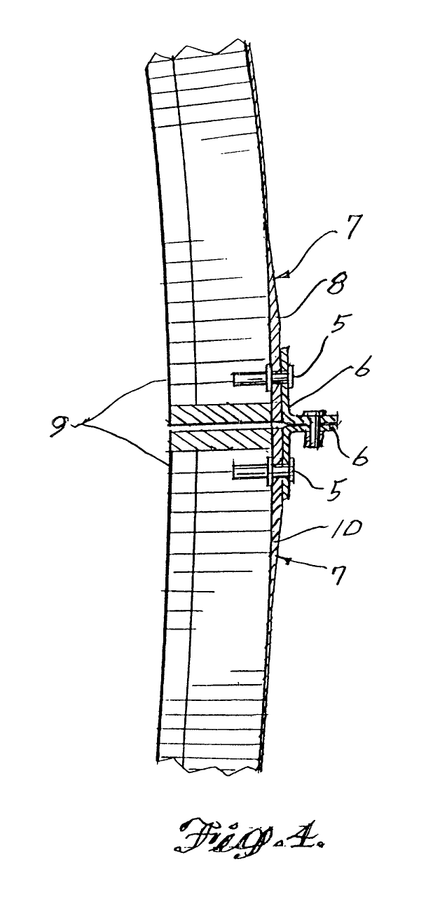

Preliminary with reference to the acoustic panel arrangement of the prior art as shown in FIG. 2 it should be noted that the attachment method shown therein comprises the use of symmetric ply build-ups on both laminates 1 high density core 2 and conventional fasteners 3 which extend through the acoustic panel result in lost acoustic treatment at attachment points 4. The high density and thick ply stackups cannot be acoustically treated with a perforated sandwich. The hereinafter-described invention allows the entire attachment area to be treated, except for a narrow edge closeout area. Adequate acoustic treatment to satisfy noise requirements in these prior art acoustic panel structures requires added nacelle length which affects performance, weight, and increases cost. This current technology limits treatable area to approximately 85% (of available area) in the engine inlet and 70% in the aircraft thrust reverser. With the prior art attachment approach, the remaining area cannot be acoustically treated.

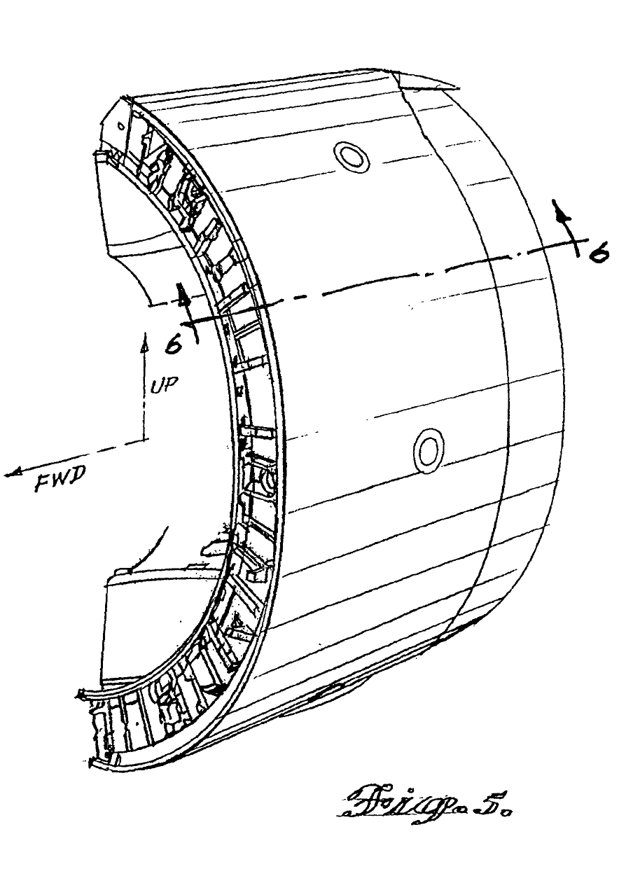

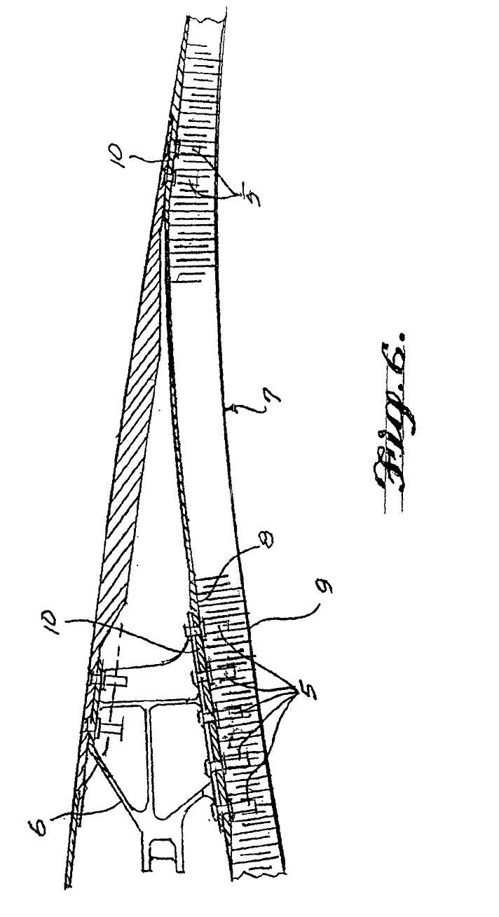

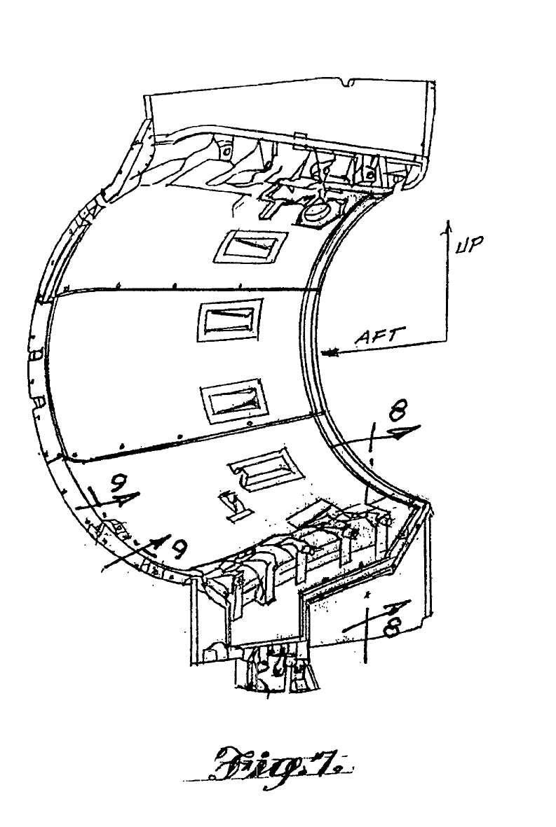

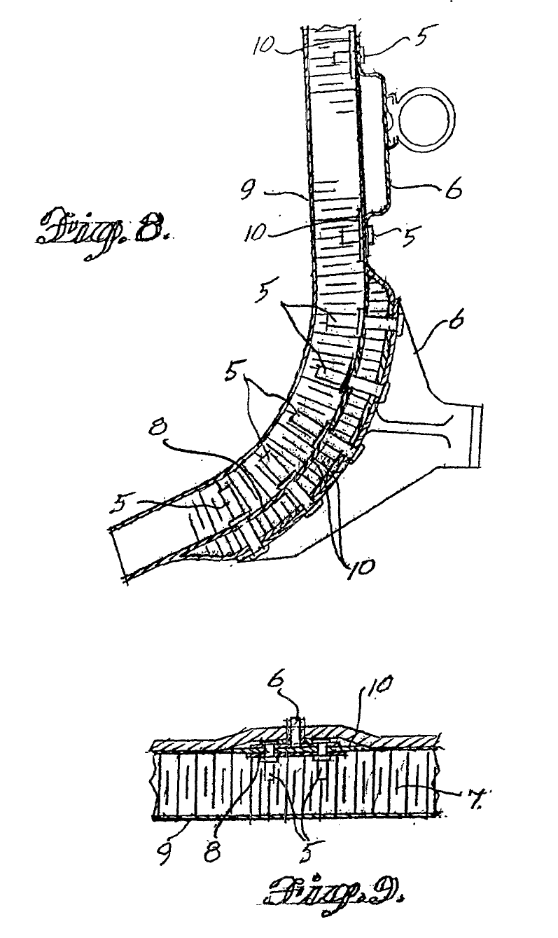

As shown in FIG. 3, FIG. 4, FIG. 6, FIG. 8 and FIG. 9, the preferred embodiment of the present invention uses fatigue rated blind bolts 5 to backside fasten the metal fitting 6 to composite acoustic panel 7. For engine nacelle applications, the blind bolts should be capable of a lengthy service life in a sonic fatigue and vibratory environment with cyclic loading. The blind bolts should offer good compliance to the irregular inner surface of the backside laminate. As the collar is deformed, it clamps up over fillets and other irregularities in the adhesive surface 8. The composite acoustic panel is constructed with a continuous perforated laminate 9 with no ply build-up. The backside laminate 10 thickness and ply build-up area are increased to react the bearing loads and to provide adequate stiffness for bending. Other panel stiffening methods include, for example, a double sandwich construction with a suitable core material.

As a result of the present acoustic panel utilizing backside fitting attachment acoustic panel material and labor costs are reduced, mainly by the elimination of high-density core and associated tooling. A significant labor savings for fastener installation is also realized over the prior art structure of FIG.2. As shown in FIG. 3 for example, the attachment of the engine inlet to the engine fan case uses aluminum attach ring-fitting 6. The attachment between the fitting and the composite panel is comprised of a double row of blind bolts 5 at a suitable spacing and pitch. For a 120″ inlet diameter, this equates to approximately 500 fasteners. In this example, a labor of savings of approximately 9 hours is realized.

The hereinafter described acoustic panel structure comprises a backside laminate and ply build up area of increased thickness for retaining blind fasteners which react the bearing loads and further provide stiffness for bending.

While a preferred embodiment of this invention has been illustrated and described, it will be appreciated that various changes can be made therein without departing from the spirit and scope of the invention. Hence, the invention can be practiced otherwise than as specifically described herein.

The embodiments of the invention in which an exclusive property or privilege is claimed are defined as follows:

1. In combination in a aircraft engine having an engine inlet,
an engine fan;
a metallic ring fitting for attaching said engine inlet to said engine fan case;
metallic fittings for attaching structural and non-structural attachments;
a composite acoustic panel disposed in said aircraft engine; and,
blind bolts for attaching said composite acoustic panel to said aluminum fitting.

2. In combination in an aircraft engine having a fan duct/thrust reverser;
an engine fan;
structural attachments using metallic fittings;
non-structural attachments using metallic brackets, studs, etc.;
composite acoustic panels disposed for said aircraft engine; and
blind bolts for attaching said composite acoustic panels to said fittings.

3. A method of attaching an acoustic panel to an aircraft structure without loss of acoustic area due to the attachment means comprising the steps of;
increasing the backside laminate ply build-up area thickness and/or adding an additional layer of core material and laminate of an acoustic panel to retain a plurality of blind fasteners; and
backside fastening said plurality of blind fasteners to the aircraft structure.
